(19) United States
(12) Patent Application Publication
(10) Pub. No.: US 2020/0327049 A1
(43) Pub. Date: Oct. 15, 2020

(54) METHOD AND SYSTEM FOR MEMORY EXPANSION WITH LOW OVERHEAD LATENCY

(71) Applicant: Alibaba Group Holding Limited, George Town (KY)

(72) Inventor: Shu Li, Bothell, WA (US)

(73) Assignee: Alibaba Group Holding Limited, George Town (KY)

(21) Appl. No.: 16/381,957

(22) Filed: Apr. 11, 2019

(51) Int. Cl. G06F 12/02; G06F 12/0875; G06F 13/16

(52) U.S. Cl. CPC G06F 12/0246; G06F 13/1668; G06F 12/0875

(57) ABSTRACT

One embodiment provides a memory module for a computer system. The memory module can include a physical enclosure encompassing at least one multi-chip packaging (MCP) module and a memory interface for coupling the MCP module to a central processing unit (CPU) of the computer system. The MCP module can include a first memory chip, an extended-memory chip, and a memory controller for controlling access to the extended-memory chip.

### BACKGROUND

### Field

This disclosure is generally related to computer memory. More specifically, this disclosure is related to a method and system that can expand the capacity of the memory without significantly increasing latency.

### Related Art

High-performance computing (HPC) systems have played important roles in the development of many new technologies, including training and simulation, on-board navigation systems, artificial intelligence (AI) technologies, computer-generated imagery (CGI) technologies, surveillance, communications, etc. By providing the ability to process data and perform complex calculations at high speeds, HPC serves as the foundation for scientific, industrial, and societal advancements. Compared to a regular desktop computer that can perform billions of calculations per second, an HPC system can perform quadrillions of calculations per second. The traditional computer architecture of the CPU, memory, and drive hierarchy can hardly meet the requirements of HPC due to the long delay caused by the drive's response time, the host interface protocol, and the limited memory capacity.

Moreover, many high performance applications (e.g., Internet of Things (IoT), AI, 3D imaging, etc.) work on a large amount of data that requires frequent read and write. Hence, the HPC system requires a large memory capacity to provide the high-bandwidth and low-latency access to huge amounts of data. Conventional memory products, such as dual in-line memory module (DIMM), are not sufficient for HPC applications.

### SUMMARY

One embodiment provides a memory module for a computer system. The memory module can include a physical enclosure encompassing at least one multi-chip packaging (MCP) module and a memory interface for coupling the MCP module to a central processing unit (CPU) of the computer system. The MCP module can include a first memory chip, an extended-memory chip, and a memory controller for controlling access to the extended-memory chip.

In a variation on this embodiment, the memory interface can include a dual in-line memory module (DIMM) interface.

In a variation on this embodiment, the extended-memory chip can include a persistent storage medium.

In a further variation, the persistent storage medium can include one or more of: a flash memory, a storage-class memory (SCM), a phase-change memory (PCM), a magnetoresistive random access memory (MRAM), and a resistive random access memory (ReRAM).

In a variation on this embodiment, the memory controller can be further configured to control access to the first memory chip, thus facilitating data movement between the first memory chip and the extended-memory chip.

In a further variation, the first memory chip can function as a cache for the extended-memory chip.

In a variation on this embodiment, the memory controller can further include an address-mapping module configured to map a physical address associated with the MCP module to a physical location within the extended-memory chip.

In a further variation, the first memory chip can include a dynamic random access memory (DRAM) chip, and the physical address associated with the MCP module can be in a DRAM address format.

One embodiment provides a system and a method for reading data. During operation, a computer receives a request to read data stored in a memory module coupled to the computer. The memory module can include at least one multi-chip packaging (MCP) module, and the MCP module can include a first memory chip, an extended-memory chip, and a memory controller for controlling access to the extended-memory chip. The computer extracts a virtual address associated with the to-be-read data from the request, and maps the virtual address to a physical location within the extended-memory chip in response to determining that the to-be-read data resides on the extended-memory chip. The computer further retrieves, via a memory interface, the to-be-read data from the physical location within the extended-memory chip.

### BRIEF DESCRIPTION OF THE FIGURES

FIG. 1 illustrates an exemplary memory-expansion approach (prior art).

FIG. 2 illustrates an exemplary memory-expansion module, according to one embodiment.

FIG. 3 illustrates the architecture of an exemplary extended-memory controller, according to one embodiment.

FIG. 4 illustrates address mapping in an exemplary memory-expansion module, according to one embodiment.

FIG. 5 presents a flowchart illustrating an exemplary memory-write process in a system that includes a memory-expansion module, according to one embodiment.

FIG. 6 presents a flowchart illustrating an exemplary memory-read process in a system that includes a memory-expansion module, according to one embodiment.

FIG. 7 shows a memory system comprising multiple memory channels, according to one embodiment.

FIG. 8 presents an apparatus for facilitating access to a memory-expansion module, according to one embodiment.

FIG. 9 conceptually illustrates an electronic system, which implements some embodiments of the subject technology.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

Embodiments of the present invention solve the technical problem of expanding the memory capacity of a computer to achieve HPC. More specifically, a multi-chip packaging (MCP)-based memory module is provided. The MCP-based memory module can expand the capacity of a conventional memory device (e.g., DRAM DIMM) by including, in the same package as a DRAM, an additional memory medium (which can be persistent) along with a controller. The controller can be configured to control access to the additional memory medium, whereas access to the DRAM can be handled by the CPU in a conventional way. Because the additional memory medium can also be accessed through the memory bus of the server (e.g., the high speed DIMM bus), it can meet the high-bandwidth and low-latency memory requirements of the HPC. A DRAM chip can also serve as a cache for the additional memory medium that is packaged along with the DRAM chip in the same MCP module.

### Memory-Expansion Module

Conventional memory devices, such as a DIMM, can provide a memory capacity at the gigabyte (GB) level (e.g., 64 GB). Such a capacity cannot meet the HPC requirement. Intel® has provided a high capacity memory product, known as Intel Apache Pass (AEP), whose memory capacity can be over 1 terabyte (TB). However, AEP requires a proprietary memory-access protocol (i.e., DDR-T) to work with specially restrained CPUs. Moreover, enabling AEP requires a considerable amount of work on BIOS (basic input/output system), OS (operation system), and server modifications, which can lead to stability and complexity problems.

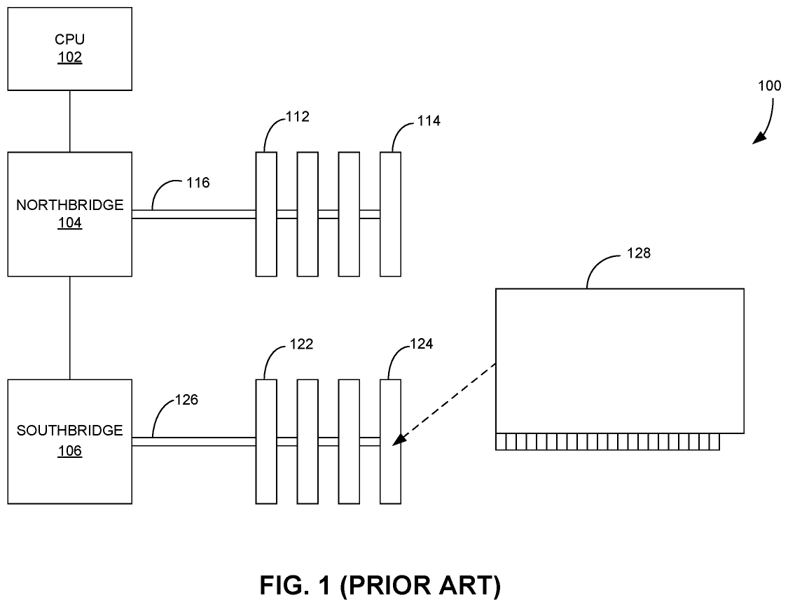

In addition to AEP, another memory-expansion approach is to connect additional storage media to the CPU via PCIe (peripheral component interconnect express) or other types of interface (e.g., CCIX (Cache Coherent Interconnect for Accelerators), Gen-Z, OpenCAPI (Open Coherent Accelerator Processor Interface), etc.). Although this approach can expand the memory capacity significantly, it suffers from the large interface latency. FIG. 1 illustrates an exemplary memory-expansion approach (prior art). In FIG. 1, a computer system 100 can include a CPU 102, a northbridge (or memory controller hub) 104, and a southbridge (or I/O controller hub 106). Memory controller hub 104 is coupled to a plurality of memory slots (e.g., memory slots 112 and 114) via a memory bus 116. The memory slots can accommodate standard memory modules, such as DIMMs. I/O controller hub 106 is coupled to a number of PCIe slots (e.g., PCIe slots 122 and 124) via a PCIe bus 126.

To expand the memory capacity, additional memory modules (e.g., additional memory module 128) can be inserted into the PCIe slots (e.g., PCIe slot 124) to allow CPU 102 to access the additional memory module through PCIe bus 126. However, this approach has a huge drawback due to the considerable overhead on latency of the PCIe and the host resource utilization. More specifically, measurements have shown that the latency of the PCIe interface can be more than five microseconds (μs), which can be magnitudes longer than the latency of a DIMM interface. Moreover, the memory-access bandwidth is also limited by the PCIe protocol.

Some embodiments provide a low-latency solution for the memory-expansion problem. More specifically, a novel memory-expansion module can be provided. The memory-expansion module can be in the form of a multi-chip package and can interface with the CPU via a high-speed memory bus (e.g., a DIMM bus), such that the CPU views the memory-expansion module as a system memory.

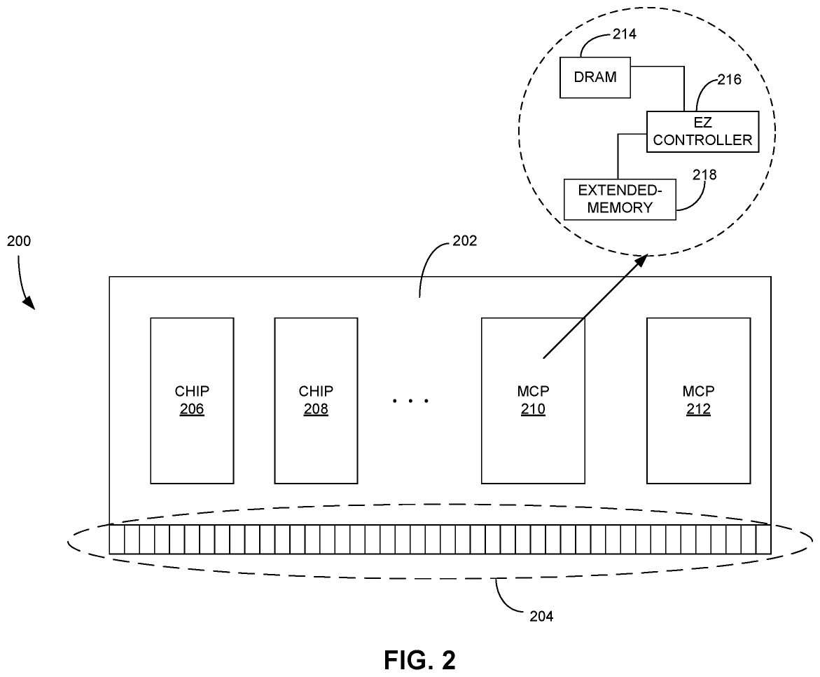

FIG. 2 illustrates an exemplary memory-expansion module, according to one embodiment. Memory-expansion module 200 can be a DIMM module that includes a physical enclosure 202 and an I/O interface 204. I/O interface 204 includes a plurality of pins, which can be arranged according to the DIMM standard. Physical enclosure 202 can enclose a number of memory chips (e.g., chips 206 and 208). In a conventional DIMM module, the memory chips can be dynamic random-access memory (DRAM) chips. However, in the example shown in FIG. 2, memory-expansion module 200 can also include one or more multi-chip packaging (MCP) modules or multi-chip modules (MCMs), such as MCP 210 and MCP 212. An MCM or MCP can refer to an electronic assembly (such as a package with a number of conductor terminals or “pins”) where multiple integrated circuits (ICs or “chips”), semiconductor dies and/or other discrete components are integrated, usually onto a unifying substrate, so that in use it is treated as if it were a single component (as though a larger IC).

FIG. 2 also shows the internal structure of an MCP (e.g., MCP 210), which can include at least one DRAM chip (e.g., DRAM chip 214), an extended-memory controller (also referred to as EZ controller) 216, and at least one extended-memory chip (e.g., extended-memory chip 218). Extended-memory chip 218 can be based on a non-persistent or persistent memory medium, such as DRAM, NotAnd (NAND) flash, magnetoresistive RAM (MRAM), phase-change memory (PCM), resistive RAM (ReRAM), storage-class memory (SCM), etc. In one embodiment, extended-memory chip 218 can be based on a persistent or non-volatile storage medium, such as NAND flash and SCM.

Extended-memory controller (or EZ controller) 216 controls access to extended-memory chip(s). In some embodiments, extended-memory controller 216 handles memory access and, hence, works on memory-access patterns, which is different from disk-drive patterns. Consequently, the structure and operation of extended-memory controller 216 can be much simpler than those of a disk-drive controller. In addition to controlling access to extended-memory chips (e.g., extended-memory chip 218), EZ controller 216 can access the DRAM chip(s) (e.g., DRAM 214) within the same MCP to move data between the DRAM and the extended-memory.

I/O interface 204 can be a standard memory interface (e.g., a DIMM interface). I/O interface 204 allows the CPU to access both the DRAMs and the extended-memory chip(s) via the high-speed memory bus, thus significantly reducing the overhead latency for accessing the extended memory.

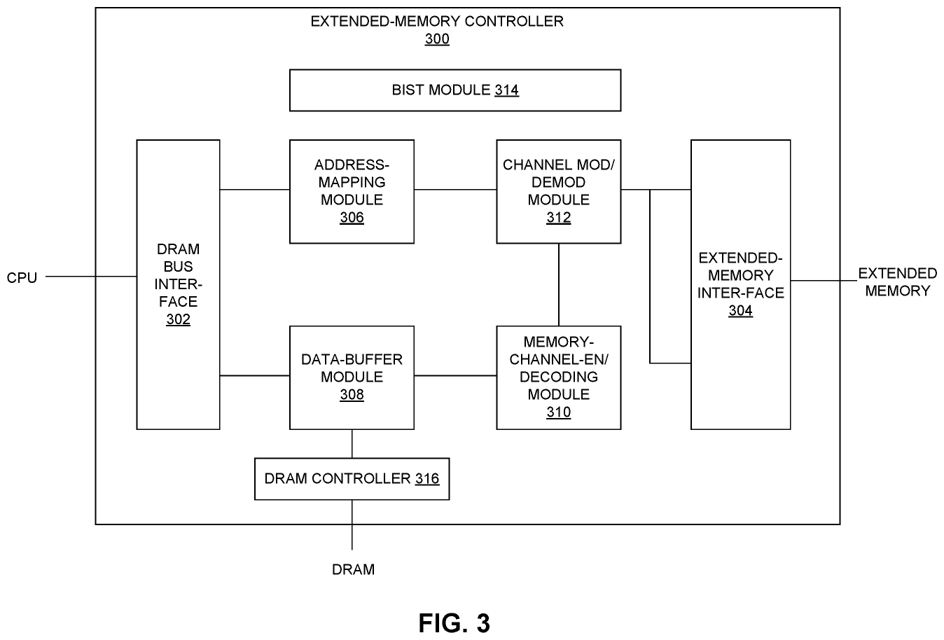

FIG. 3 illustrates the architecture of an exemplary extended-memory controller, according to one embodiment. Extended-memory controller 300 can include a memory-bus interface 302 for interfacing with the CPU and an extended-memory interface 304 for interfacing with the extended memory. Extended-memory controller 300 can further include an address-mapping module 306, a data-buffer module 308, a memory-channel-encoding/decoding module 310, a channel modulation/demodulation module 312, a built-in self test module 314, and a DRAM controller 316 for interfacing with the DRAM chip that is packaged together in the same MCP with the extended memory and extended-memory controller 300.

More specifically, address-mapping module 306 can be responsible for mapping a logical address of the data to a physical address in the extended-memory media. A detailed discussion regarding address mapping in the extended-memory media will come later. Data-buffer module 308 can be responsible for temporarily storing the data (e.g., data pages) to be written into the extended memory. In some embodiments, data-buffer module 308 can include static random-access memory (SRAM). Memory-channel-encoding/decoding module 310 can be responsible for encoding/decoding data. In some embodiments, memory-channel-encoding/decoding module 310 can encode/decode data using predetermined error correction codes. Channel modulation/demodulation module 312 can be responsible for modulating/demodulating the encoded data using a predetermined modulation scheme. The modulated data can then be written into the extended-memory media based on the mapped address via extended-memory interface 304.

Built-in self test (BIST) module 314 can be responsible for performing various self tests to ensure that the extended memory functions normally. In some embodiments, BIST module 314 can perform tests using memory patterns on the extended memory. DRAM controller 316 allows extended-memory controller 300 to control the DRAM that is packaged together in the same MCP with the extended-memory medium. More specifically, DRAM controller 316 facilitates movements of data between the DRAM and the extended-memory medium. Note that the DRAM chip typically has a smaller capacity and a faster speed than the extended-memory medium. In some embodiments, the DRAM chip can also serve as a cache for the extended-memory medium. “Hot” or frequently accessed data can reside on the DRAM, and “cold” or infrequently accessed data can be moved to the extended-memory medium via DRAM controller 316.

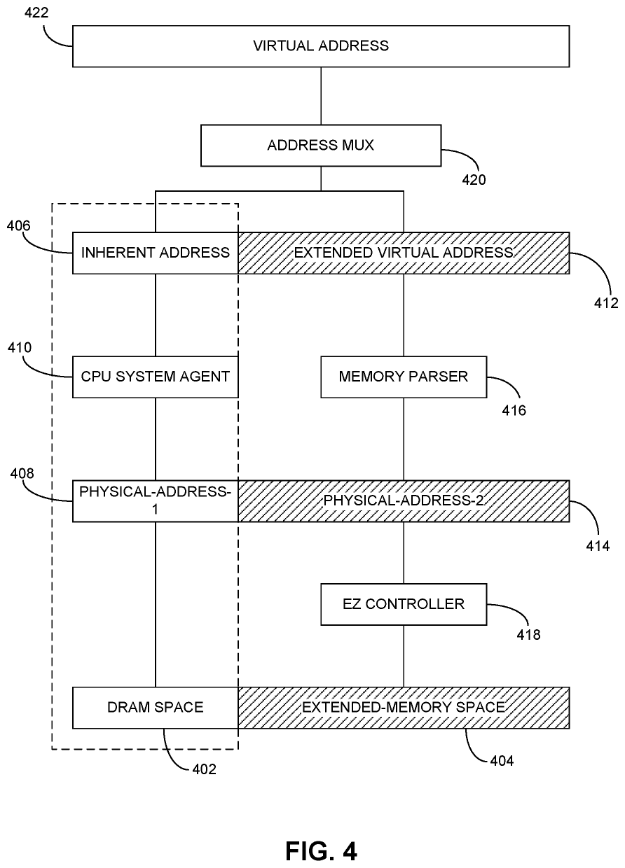

FIG. 4 illustrates address mapping in an exemplary memory-expansion module, according to one embodiment. As discussed before, a memory-expansion module can include a non-persistent memory (e.g., DRAM) medium and a memory-expansion medium, which can be non-persistent or persistent. In some embodiments, the memory-expansion medium can be based on a persistent memory medium, such as NAND flash or SCM. Accordingly, the virtual memory space can also include two portions, DRAM space 402 and extended-memory space 404, as shown in FIG. 4. DRAM space 402 can be faster but has limited capacity. On the other hand, extended-memory space 404 can have a larger capacity but often requires longer access latency.

The address mapping to a location in DRAM space 402 is shown on the left side of FIG. 4 (encompassed by the dashed rectangle) and can be similar to a standard DRAM address mapping process. More specifically, when received data needs to be stored in DRAM space 402, the virtual address (referred to in FIG. 4 as inherent address 406) can be mapped to a physical address (referred to in FIG. 4 as physical-address-1 408) by CPU system agent 410. Physical-address-1 408 corresponds to a physical location in DRAM space 402. The DRAM virtual address is referred to as an inherent address because the memory-expansion module is coupled to the CPU via the standard DRAM DIMM interface and the CPU accesses the DRAMs in a way that is inherent to the CPU.

On the other hand, when received data needs to be stored in extended-memory space 404, the virtual address of the data (referred to as extended virtual address 412 in FIG. 4) can be mapped to a physical address (referred to as physical-address-2 414 in FIG. 4) by a memory parser 416. In some embodiments, memory parser 416 can compute a hash function online to map extended virtual address 412 to physical-address-2 414. Because, like the DRAMs, the extended-memory medium is accessed via the standard DRAM DIMM interface, physical-address-2 414 can be in the memory space domain of DIMM format, although the extended memory medium is not necessarily organized the same way as the DIMM. Physical-address-2 414 can also be considered as the physical address inside the MCP, which points to a location within the MCP. Depending on the type of physical medium used to achieve the memory expansion, the extended-memory controller (i.e., EZ controller 418) can accomplish the eventual address mapping to map physical-address-2 414 to a physical location in the extended-memory medium.

An address multiplexer module 420 can be responsible for forming a complete virtual address space 422 by combining the address space provided by the DRAM (i.e., DRAM space 402) and the address space provided by the extended memory (i.e., extended-memory space 404). DRAM space 404 and extended-memory space 404 can have similar formats but different ranges. Applications are provided with the combined address space for their memory needs.

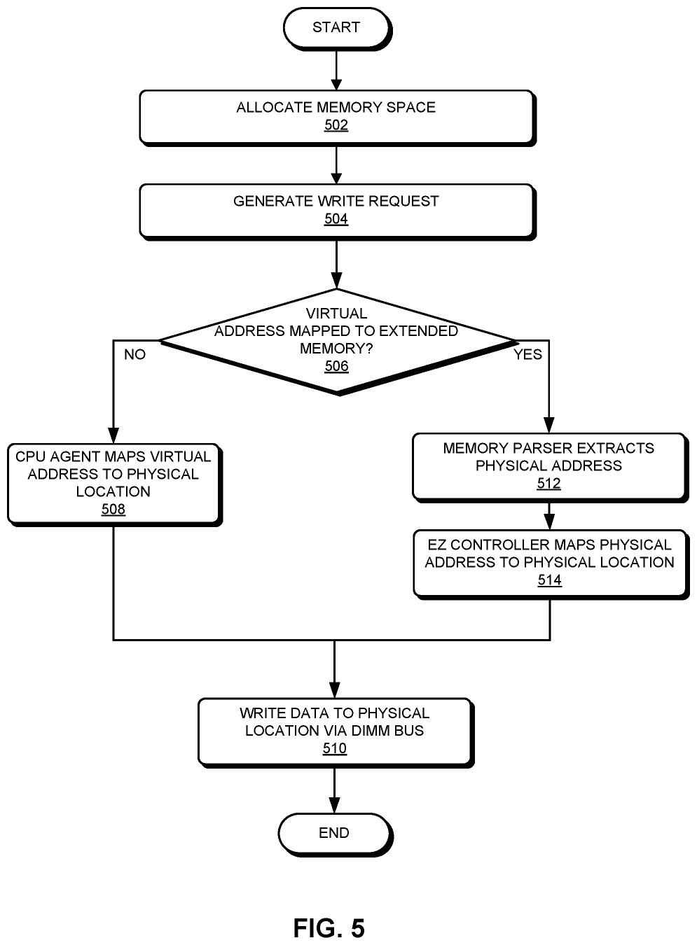

FIG. 5 presents a flowchart illustrating an exemplary memory-write process in a system that includes a memory-expansion module, according to one embodiment. The memory-expansion module can include one or more memory-expansion MCPs and can be coupled to the CPU of the computer system via a standard DIMM interface. The MCP can enclose an inherent DRAM as well as an extended-memory medium, which can be persistent. In this example, applications running on a computer coupled to the memory-expansion module are aware of the existence of the extended-memory medium. In other words, the applications are aware of the traditional non-persistence memory (e.g., the DRAMs) as well as the extended-memory medium (which can include a persistent storage medium, such as NAND flash and SCM). Depending on performance requirements or expectations, an application can allocate memory spaces for writing data (operation 502). In other words, the application may choose to write data in the DRAM or the extended-memory medium based on the performance requirements. As discussed previously, the DRAM can be accessed with low latency but have a smaller capacity, whereas the extended-memory medium can have a larger capacity but requires a longer access time. If the application needs fast access to a smaller amount of data, the application should use the DRAM for data storage; otherwise, the application should use the extended-memory medium.

The application then generates a write request to the virtual memory space (operation 504). In some embodiments, the write request can include a virtual address. Note that the application may generate a virtual address corresponding to the inherent DRAM or a virtual address corresponding to the extended-memory medium, depending on whether the application's need to store the data in the DRAM or the extended-memory medium.

The system then determines whether the virtual address included in the write request is mapped to the extended-memory medium (operation 506). If not, the virtual address is mapped to inherent DRAM, and the CPU system agent (which can be located within the CPU and can include a memory controller module) can map the virtual address to a physical location in the inherent DRAM (operation 508) and write the data to the physical location via the DIMM bus (operation 510). Note that writing the data involves channel encoding and modulation.

The address mapping performed by the CPU system agent can be similar to a conventional memory address mapping. If the virtual address is mapped to the extended-memory medium, the existing controller in the CPU system agent is not equipped to deal with such an address. Instead, a memory parser can be used to handle such an address. The memory parser can be a software module residing inside or outside the CPU. The memory parser can extract a physical address within the MCP from the virtual address (operation 512). More specifically, the memory parser can translate the virtual address to a physical address, which is still in the DRAM domain and point to a location in the MCP. In some embodiments, the memory parser needs to compute a hash function based on the virtual address. Subsequently, the extended-memory controller (or the EZ controller) can map the physical address to a physical location in the extended-memory medium (operation 514). In other words, the EZ controller translates the physical address in the DRAM domain to an actual physical address in the memory medium domain. The data can then be written to the physical location via the DIMM bus (operation 510).

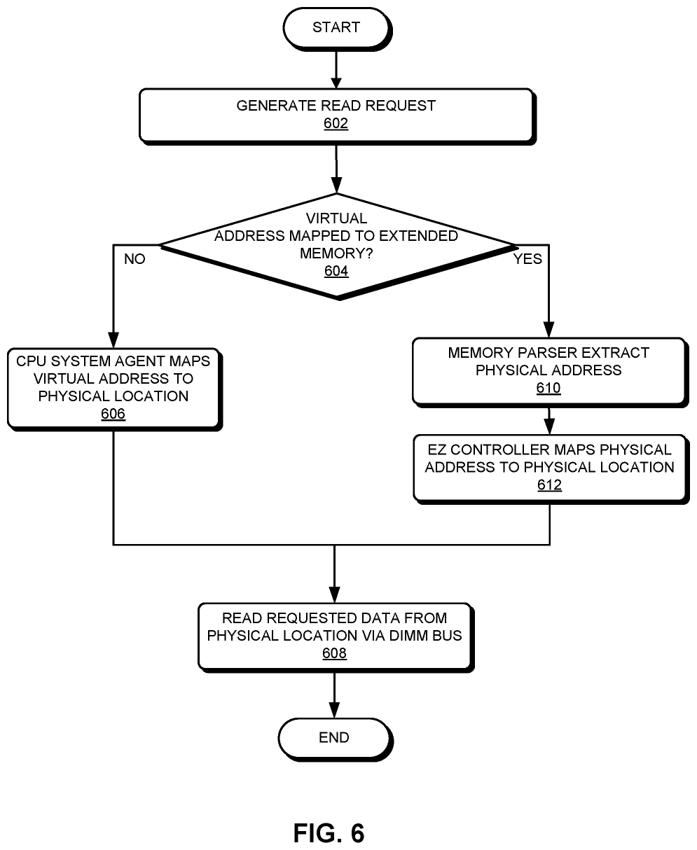

FIG. 6 presents a flowchart illustrating an exemplary memory-read process in a system that includes a memory-expansion module, according to one embodiment. The memory-expansion module can include one or more memory-expansion MCPs and can be coupled to the CPU of the computer system via a standard DIMM interface. The MCP can enclose an inherent DRAM as well as an extended-memory medium, which can be persistent. During operation, an application running on a computer coupled to the memory-expansion module generates a read request to access data stored in the extended-memory module (operation 602). The read request can include a virtual address of the to-be-read data. The system determines whether the virtual address included in the read request maps to the extended-memory medium included in the MCP (operation 604). If not, the data resides on the inherent DRAM. Consequently, the CPU system agent can map the virtual address to a physical location in the inherent DRAM (operation 606) and read the requested data from the physical location via the DIMM bus (operation 608). Note that reading the data can involve demodulation and decoding operations.

If the virtual address maps to the extended-memory medium, the CPU system agent is not able to handle such a virtual address. Instead, a memory parser can extract a physical address of the MCP in the DRAM domain from the virtual address (operation 610). The extracted physical address is passed to the EZ controller, which maps the MCP physical address to an actual physical location in the extended-memory medium (operation 612). The system then reads the requested data from the physical location via the DIMM bus (operation 608).

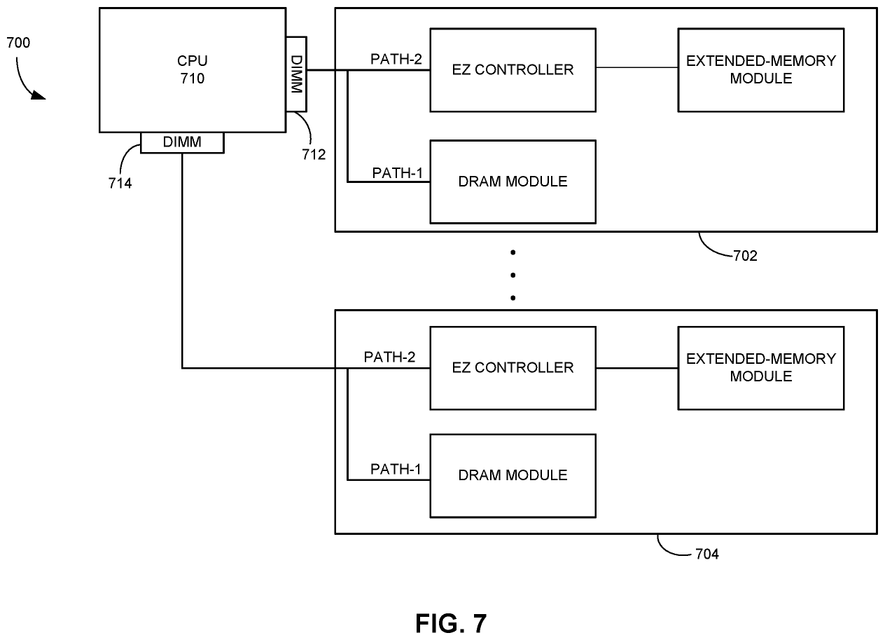

In some embodiments, a CPU can be coupled to multiple independent memory channels, with each channel including at least one memory-expansion module or memory-expansion MCP. By expanding local memory in each channel, the memory of the system can be significantly expanded. FIG. 7 shows a memory system comprising multiple memory channels, according to one embodiment. In FIG. 7, memory system 700 can include a plurality of parallel memory channels accessible by CPU 710. More specifically, each memory channel can include a standard DIMM interface for coupling a memory-expansion module to CPU 710. For example, memory-expansion module 702 can be coupled to CPU 710 via DIMM interface 712, and memory-expansion module 704 can be coupled to CPU 710 via DIMM interface 714. Each memory channel can be managed by a memory controller residing in CPU 710. Each memory-expansion module can include an MCP that includes a regular DRAM module (which can include one or more DRAM chips) and an extended-memory module (which can include one or more persistent or non-persistent storage chips). In some embodiments, the extended-memory module included in the MCP can include a persistent or non-volatile storage medium (e.g., NAND flash and SCM). In addition, each memory-expansion module can include an extended-memory controller (i.e., an EZ controller) for controlling access to the extended-memory module. Note that access control to the regular DRAM module is inherent to and handled by CPU 710.

From the point of view of CPU 710, the DRAM module in each memory channel can be accessed the same way that a CPU accesses a conventional memory. On the other hand, access to the extended-memory module is controlled by the EZ controller, which is responsible for address mapping, data encoding/decoding, and signal modulation/demodulation. In FIG. 7, the direct path to the DRAM module is marked as path-1, and the path to the extended-memory module is marked as path-2.

Moreover, the DRAM module can be accessed by the EZ controller, which moves pages of data between the extended-memory module and the DRAM module. For example, if one or more pages of data in the DRAM module become “cold,” (i.e., they are less frequently accessed), they can be moved from the DRAM module to the extended-memory module, vacating the DRAMs for data that needs fast access. When pages of data are moved, the corresponding address mapping needs to be updated. Note that both the CPU system agent and the EZ controller need to update the address mapping in response to the data being moved from the DRAM module to the extended-memory module. In some embodiments, a memory parser, which can reside in the CPU or reside on a separate module coupled to the CPU, also needs to update its address mapping by computing a physical address in the MCP. Moreover, when the DRAM module is not fully used or occupied, it can be used as the cache for the extended-memory module to improve the overall performance of the extended-memory module through the coordination of the EZ controller.

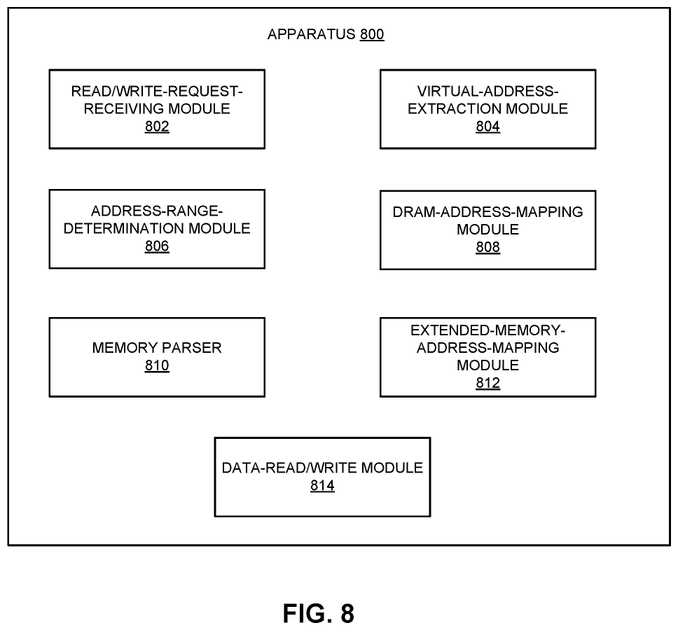

FIG. 8 presents an apparatus for facilitating access to a memory-expansion module, according to one embodiment. Apparatus 800 can include a read/write-request-receiving module 802, a virtual-address-extraction module 804, an address-range-determination module 806, a DRAM-address-mapping module 808, a memory parser 810, an extended-memory-address-mapping module 812, and a data-read/write module 814.

Read/write-request-receiving module 802 can be responsible for receiving a memory read or write request from applications. These applications are typically aware of the two types of memory medium included in the memory-expansion module and can generate the read/write request based on the performance expectation or needs. Virtual-address-extraction module 804 can be responsible for extracting the virtual address associated with the to-be-read or to-be-written data from the read/write request. Address-range-determination module 806 can be responsible for determining the range of the virtual address in order to determine whether the memory space associated with the virtual request is located on the regular DRAM module or on the extended-memory module, both of which are packaged into the same MCP together with an EZ controller for controlling access to the extended-memory module.

DRAM-address-mapping module 808 can be responsible for mapping a virtual address to a physical address in the regular DRAM module, in response to the system determining that such a virtual address is within the range of the DRAM module. Memory parser 810 can be responsible for mapping a virtual address to a physical address in the extended memory, in response to the system determining that such a virtual address is within the range of the extended-memory module. Note that memory parser 810 maps the virtual address to a physical address in the DRAM address format. For example, the physical address can specify rows and columns of a DRAM. In other words, memory parser 810 assumes that the extended-memory module is organized similarly to a conventional DRAM DIMM.

Extended-memory-address-mapping module 812 can be responsible for mapping the physical address outputted by memory parser 810 to an actual physical location within the extended-memory module, depending on the type of memory medium included in the extended-memory module. Data read/write module 814 can be responsible for reading data from and writing data into the memory-expansion module, which can include the DRAM module and the extended-memory module.

In general, embodiments of the present invention provide a novel memory system which can expand the capacity of a conventional DRAM DIMM module by including, in the same DIMM package, memory-expansion MCPs, with each MCP including a conventional DRAM, an extended-memory medium, and a corresponding memory controller. The extended-memory medium can be based on a non-volatile storage medium (e.g., NAND flash and SCM), thus providing non-volatile fast memory to the CPU. Such a modification to the conventional DIMM module can be transparent to the CPU, which can access both the DRAM and the extended-memory medium in the MCP via the fast DIMM interface. In addition to DIMM, other fast memory interfaces, such as non-volatile DIMM (NVDIMM) and single in-line memory module (SIMM), can also be used to couple the memory-expansion module to the CPU of the server computer. Compared to the PCIe-based memory-expansion solution, the current solution can provide much lower memory-access latency and requires no modifications to the hardware and architecture of the server.

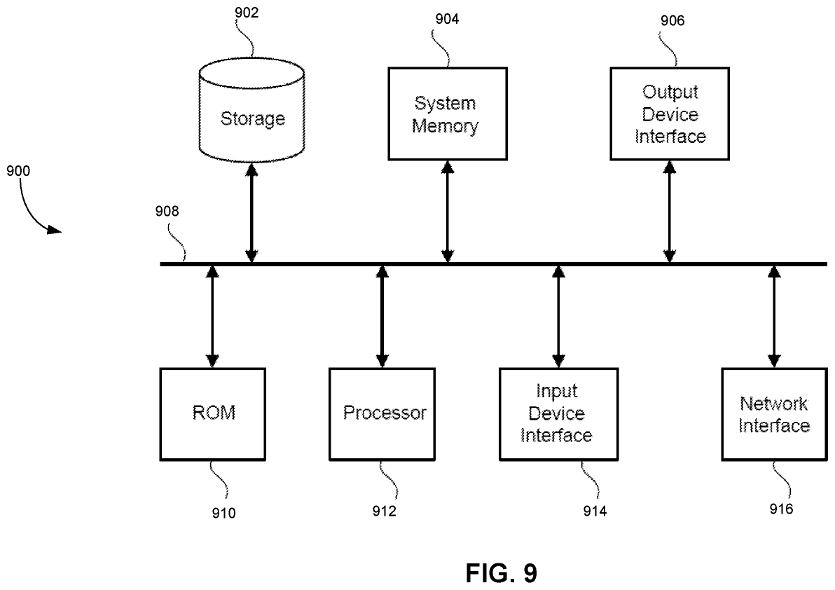

FIG. 9 conceptually illustrates an electronic system, which implements some embodiments of the subject technology. Electronic system 900 can be a client, a server, a computer, a smartphone, a PDA, a laptop, or a tablet computer with one or more processors embedded therein or coupled thereto, or any other sort of electronic device. Such an electronic system includes various types of computer-readable media and interfaces for various other types of computer-readable media. Electronic system 900 includes a bus 908, processing unit(s) 912, a system memory 904, a read-only memory (ROM) 910, a permanent storage device 902, an input device interface 914, an output device interface 906, and a network interface 916.

Bus 908 collectively represents all system, peripheral, and chipset buses that communicatively connect the numerous internal devices of electronic system 900. For instance, bus 908 communicatively connects processing unit(s) 912 with ROM 910, system memory 904, and permanent storage device 902.

From these various memory units, processing unit(s) 912 retrieves instructions to execute and data to process in order to execute the processes of the subject disclosure. The processing unit(s) can be a single processor or a multi-core processor in different implementations.

ROM 910 stores static data and instructions that are needed by processing unit(s) 912 and other modules of the electronic system. Permanent storage device 902, on the other hand, is a read-and-write memory device. This device is a non-volatile memory unit that stores instructions and data even when electronic system 900 is off. Some implementations of the subject disclosure use a mass-storage device (such as a magnetic or optical disk and its corresponding disk drive) as permanent storage device 902.

Other implementations use a removable storage device (such as a floppy disk, flash drive, and various types of disk drive) as permanent storage device 902. Like permanent storage device 902, system memory 904 is a read-and-write memory device. However, unlike storage device 902, system memory 904 is a volatile read-and-write memory, such as a random access memory. System memory 904 stores some of the instructions and data that the processor needs at runtime. In some implementations, the processes of the subject disclosure are stored in system memory 904, permanent storage device 902, and/or ROM 910. From these various memory units, processing unit(s) 912 retrieves instructions to execute and data to process in order to execute the processes of some implementations.

Bus 908 also connects to input and output device interfaces 914 and 906, respectively. Input device interface 914 enables the user to communicate information and send commands to the electronic system. Input devices used with input device interface 914 include, for example, alphanumeric keyboards and pointing devices (also called “cursor control devices”). Output device interface 906 enables, for example, the display of images generated by the electronic system 900. Output devices used with output device interface 906 include, for example, printers and display devices, such as cathode ray tubes (CRT) or liquid crystal displays (LCD). Some implementations include devices such as a touchscreen that function as both input and output devices.

Finally, as shown in FIG. 9, bus 908 also couples electronic system 900 to a network (not shown) through a network interface 916. In this manner, the computer can be a part of a network of computers (such as a local area network (“LAN”), a wide area network (“WAN”), an intranet, or a network of networks, such as the Internet. Any or all components of electronic system 900 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A memory module for a computer system, comprising:
a physical enclosure encompassing at least one multi-chip packaging (MCP) module; and
a memory interface for coupling the MCP module to a central processing unit (CPU) of the computer system;
wherein the MCP module comprises:
a first memory chip;
an extended-memory chip; and
a memory controller for controlling access to the extended-memory chip.

2. The memory module of claim 1, wherein the memory interface comprises a dual in-line memory module (DIMM) interface.

3. The memory module of claim 1, wherein the extended-memory chip comprises a persistent storage medium.

4. The memory module of claim 3, wherein the persistent storage medium comprises one or more of:
a flash memory;
a storage-class memory (SCM);
a phase-change memory (PCM);
a magnetoresistive random access memory (MRAM); and
a resistive random access memory (ReRAM).

5. The memory module of claim 1, wherein the memory controller is further configured to control access to the first memory chip, thus facilitating data movement between the first memory chip and the extended-memory chip.

6. The memory module of claim 5, wherein the first memory chip can function as a cache for the extended-memory chip.

7. The memory module of claim 1, wherein the memory controller further comprises an address-mapping module configured to map a physical address associated with the MCP module to a physical location within the extended-memory chip.

8. The memory module of claim 7, wherein the first memory chip comprises a dynamic random access memory (DRAM) chip, and wherein the physical address associated with the MCP module is in a DRAM address format.

9. A computer-implemented method, comprising:
receiving, by a computer, a request to read data stored in a memory module coupled to the computer, wherein the memory module comprises at least one multi-chip packaging (MCP) module, and wherein the MCP module comprises a first memory chip, an extended-memory chip, and a memory controller for controlling access to the extended-memory chip;
extracting a virtual address associated with the to-be-read data from the request;
in response to determining that the to-be-read data resides on the extended-memory chip, mapping the virtual address to a physical location within the extended-memory chip; and
retrieving, via a memory interface, the to-be-read data from the physical location within the extended-memory chip.

10. The computer-implemented method of claim 9, wherein the memory interface comprises a dual in-line memory module (DIMM) interface.

11. The computer-implemented method of claim 9, wherein the extended-memory chip comprises a persistent storage medium.

12. The computer-implemented method of claim 11, wherein the persistent storage medium comprises one or more of:
a flash memory;
a storage-class memory (SCM);
a phase-change memory (PCM);
a magnetoresistive random access memory (MRAM); and
a resistive random access memory (ReRAM).

13. The computer-implemented method of claim 9, wherein the first memory chip comprises a dynamic random access memory (DRAM) chip, and wherein mapping the virtual address to a physical location within the extended-memory chip comprises:
converting, by a memory parser running on the computer, the virtual address to a physical address associated with the MCP module, wherein the physical address is in a DRAM format; and
mapping, by the memory controller within the MCP module, the physical address in the DRAM format to the physical location within the extended-memory chip.

14. The computer-implemented method of claim 9, further comprising:
in response to determining that the to-be-read data resides on the first memory chip, retrieving the to-be-read data from the first memory chip via the memory interface.

15. The computer-implemented method of claim 9, further comprising:
receiving a write request to write data to the memory module;
in response to determining that the data is to be written into the extended-memory chip based on a second virtual address associated with the write request, mapping the second virtual address to a second physical location within the extended-memory chip; and
writing, via the memory interface, the data at the second physical location within the extended-memory chip.

16. A non-transitory computer-readable storage medium storing instructions that when executed by a computer cause the computer to perform a method, the method comprising:
receiving, by a computer, a request to read data stored in a memory module coupled to the computer, wherein the memory module comprises at least one multi-chip packaging (MCP) module, and wherein the MCP module comprises a first memory chip, an extended-memory chip, and a memory controller for controlling access to the extended-memory chip;
extracting a virtual address associated with the to-be-read data from the request;
in response to determining that the to-be-read data resides on the extended-memory chip, mapping the virtual address to a physical location within the extended-memory chip; and
retrieving, via a memory interface, the to-be-read data from the physical location within the extended-memory chip.

17. The computer-readable storage medium of claim 16, wherein the memory interface comprises a dual in-line memory module (DIMM) interface.

18. The computer-readable storage medium of claim 16, wherein the extended-memory chip comprises a persistent storage medium.

19. The computer-readable storage medium of claim 16, wherein the first memory chip comprises a dynamic random access memory (DRAM) chip, and wherein mapping the virtual address to a physical location within the extended-memory chip comprises:
converting, by a memory parser running on the computer, the virtual address to a physical address associated with the MCP module, wherein the physical address is in a DRAM format; and
mapping, by the memory controller within the MCP module, the physical address in the DRAM format to the physical location within the extended-memory chip.

20. The computer-readable storage medium of claim 16, wherein the method further comprises:
receiving a write request to write data to the memory module;
in response to determining that the data is to be written into the extended-memory chip based on a second virtual address associated with the write request, mapping the second virtual address to a second physical location within the extended-memory chip; and
writing, via the memory interface, the data at the second physical location within the extended-memory chip.
